(19) United States
(12) Patent Application Publication
(10) Pub. No.: US 2010/0063797 A1
(43) Pub. Date: Mar. 11, 2010

(54) DISCOVERING QUESTION AND ANSWER PAIRS

(75) Inventors: Gao Cong, Aalborg (DK); Chin-Yew Lin, Beijing (CN)

Correspondence Address: PERKINS COIE LLP/MSFT, P. O. BOX 1247, SEATTLE, WA, 98111-1247, US

(73) Assignee: Microsoft Corporation, One Microsoft Way, WA (US)

(21) Appl. No.: 12/207,199

(22) Filed: Sep. 9, 2008

(51) Int. Cl. G06F 17/27

(52) U.S. Cl. 704/9

(57) ABSTRACT

The present invention provides a new approach to extracting question-answer pairs from online forums. The system develops a classification-based technique to discover questions in forums using sequential patterns automatically extracted from both questions and non-question sentences in forums as features. Once the questions are discovered, the system discovers the answers. The invention includes a graph-based method is that it is complementary with supervised methods for knowledge extraction, and techniques for question answering.

### BACKGROUND

An online forum is a web application for holding discussions and posting user generated content in a specific domain, such as sports, recreation, techniques, travel etc. Since forums may contain a large amount of valuable user generated content on a variety of topics, it is highly desirable if the human knowledge contained in user generated content in forums can be extracted and reused.

Although it is highly valuable and desirable to extract question answer pairs embedded in forums, existing systems do not address the problems associated with mining unstructured data in such forums. Each forum thread usually contains an initiating post and a couple of reply posts. The initiating post usually contains several questions and reply posts may contain answers to the questions in the initiating post or new questions. The asynchronous nature of forum discussion makes it common for multiple participants to pursue multiple questions in parallel, all of which makes effective mining very difficult.

### SUMMARY

A system for discovering question and answer pairs is provided. In one specific example, the invention includes mining question-answer pairs from forums. The system develops a classification-based technique to discover questions in forums using sequential patterns automatically extracted from both questions and non-question sentences in forums as features. Once the questions are discovered, the system discovers the answers. In one embodiment, answers are discovered by the use of a graph-based method and classification method. First, for each candidate answer and question pair, the results returned by graph-based methods can be added as features for classification method to determine if the candidate answer is an answer of the question. The returned classification score for each candidate answer will be used to rank all the candidate answers of a question. In doing so, the classification model can make use of the relationship between candidate answers. Second, the classification score returned by a classifier is often, or can be, transformed into the probability for a candidate answer being a true answer and can be used as initial score for propagation of graph-based model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an example of a graph built from candidate answers.

FIG. 2 illustrates a table of data from performance of question detection.

FIG. 3 illustrates a table of data from methods and their abbreviations.

FIG. 4 illustrates a table of data showing results on A-T Union data.

FIG. 5 illustrates a table of data showing results on A-T Inter data.

FIG. 6 illustrates a table of data showing results on first question subset of A-T Union data.

FIG. 7 illustrates a table of data showing the evaluation of graph-based method on A-T Union data.

FIG. 8 illustrates a table of data showing the integration of graph-based method and classification.

FIG. 9 illustrates a table of data showing the number of extracted question and answer pairs.

FIG. 10 illustrates a table of data showing the evaluation on a second set of data.

FIG. 11 illustrates a block diagram of one embodiment of the invention.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “evaluator,” “sensor,” “device,” “cloud,” “network,” “optimizer,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

The present invention relates to the process of mining knowledge in the form of question-answer (QA) pairs from forums. There are two main processes involved: question detection and answer detection.

In one aspect of the present invention, the objective is to detect the questions within a forum thread. Questions in forums are often stated in an informal way and questions are stated in various formats. Thus, standard search methods such as those that look for a question mark are not adequate. Briefly described, the present invention develops a classification-based technique to detect questions in forums using sequential patterns automatically extracted from both questions and non-question sentences in forums as features.

Once the questions are identified, the invention finds the answer passages within the same forum thread. Answer detection is difficult for a number of reasons. First, multiple questions and answers may be discussed in parallel and are often inter-weaved together, and the reply relationship between posts is usually unavailable. Second, one post may contain answers to multiple questions and one question may have multiple replies. One approach to finding answer is to cast answer-finding as a traditional document retrieval problem by considering each candidate answer as an isolated document and the question as a query. Ranking methods are then employed, such as cosine similarity, query likelihood language model and KL-divergence language model. However, these methods do not consider the relationship of candidate answers and forum-specific features, such as the distance of a candidate answer from a question.

To model the relationship between candidate answers and make use of forum-specific features, the present invention provides a new graph-based approach for answer detection. The new method models the relationship between answers to form a graph using a combination of three factors, the probability assigned by language model of generating one candidate answer from the other candidate answer, the distance of candidate answer from question, and the authority of authors of candidate answer in forums. For each candidate answer, the method computes an initial score of being a true answer using a ranking method. To use the graph to compute a final propagated score, the invention considers at least two methods. The first one integrates the initial score after propagation, while the second one integrates the initial score in the process of propagation.

The following describes algorithms for detecting questions. As noted above, detection methods that use simple rules in forums, such as the detection of a question mark and 5W1H words, are not adequate. With question mark as an example, there are many question posts that do not end with question marks. This is due to the fact that questions can be expressed by imperative sentences, e.g., “I am wondering where I can buy cheap and good clothing in Beijing.” In addition, short informal expressions, may end with a question mark but it may not be a question, such as “really?” To complement the inadequacy of simple rules, the present invention extracts labeled sequential patterns from both questions and non-questions to characterize them, and then use the discovered patterns as features to build classifiers for question detection. Labeled sequential patterns are used to identify comparative sentences and erroneous sentences.

The following description first explains labeled sequential patterns (LSPs) and then presents how to use them for question detection. Consider a question, “I want to buy office software and wonder which software company is best.” In this example, “wonder which . . . is” would be a good pattern to characterize the question. A labeled sequential pattern (LSP), p, is an implication in the form of LHS→c, where LHS is a sequence and c is a class label. Let “I” be a set of items and L be a set of class labels. Let D be a sequence database in which each tuple is composed of a list of items in/and a class label in L. A sequence s₁=<a₁, . . . , aₘ> is contained in a sequence s₂=<b₁ . . . , bn> if 1) there exist integers i₁, . . . iₘ such that 1≦i₁<i₂< . . . <iₘ≦n and aⱼ=bᵢⱼ for all j ┐ 1, . . . , m, and 2) the distance between the two adjacent items bᵢⱼ and bᵢⱼ+1 in s₂ needs to be less than a threshold, λ, which could be, for example, 5. Similarly, it is said that a LSP p₁ is contained by p₂ if the sequence p₁. LHS is contained by p₂. LHS and p₁.c=p₂.c. In some cases, it may not be required to have s₁ appear continuously in s₂.

The support of p, denoted by sup(p), is the percentage of tuples in database D that contain the LSP p. The probability of the LSP p being true is referred to as “the confidence of p”, denoted by conf(p), and is computed as:

$$\frac{sup ( p )}{sup ( p , LHS )}$$

The support is to measure the generality of the pattern p and minimum confidence is a statement of predictive ability of p. For example, consider a sequence database containing three tuples t₁=(<a, d, e, f>,Q), t₂=(<a, f, e, f>,Q) and t₃=(<d, a, f>,NQ). One example LSP p₁=<a, e, f>→Q, which is contained in tuples t₁ and t₂. Its support is 66.7% and its confidence is 100%. As another example, LSP p₂=<a, f>→Q with support 66.7% and confidence 66.7%. The value of p₁ is a better indication of class Q than p₂.

To mine LSPs, it is optimal to pre-process each sentence by applying Part-Of-Speech (POS) tagger MXPOST Toolkit² to tag each sentence while keeping keywords including 5W1H, modal words, “wonder”, “any” etc. For example, the sentence “where can you find a job” is converted into “where can PRP VB DT NN”, where “PRP”, “VB”, “DT” and “NN” are POS tags. Each processed sentence becomes a database tuple. Note that the keywords are usually good indications of questions while POS tags can reduce the sparseness of words. The combination of POS tags and keywords allows us to capture representative features for question sentences by mining LSPs. Some example LSPs include “<anyone, VB, how>→Q”, and “<what, do, PRP, VB>→Q”. Note that the confidences of the discovered LSPs are not necessary 100%, their lengths are flexible and they can be composed of contiguous or distant words/tags.

Given a collection of processed data, LSPs are mined by imposing both minimum support threshold and minimum confidence threshold. The minimum support threshold is to ensure that the discovered patterns are general while the minimum confidence threshold ensures that all discovered LSPs are discriminating and are capable of predicting question or non-question sentences. In one implementation, minimum support can be set at 0.5% and minimum confidence at 85%. Existing frequent sequential pattern mining algorithms do not consider minimum confidence constraint. The present invention adapts it to mining LSPs with constraints. Each discovered LSP forms a binary feature as the input for classification model. If a sentence includes an LSP, the corresponding feature is set at 1. The method builds a SVM classifier to detect questions.

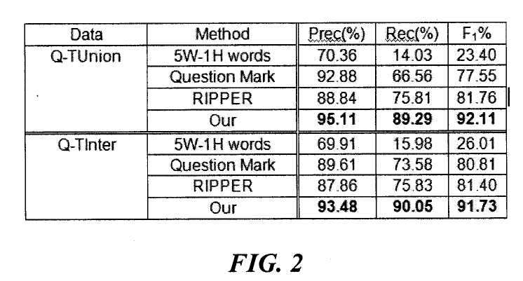

Following the question detection method, the invention includes an answer detection method. FIG. 2 presents a technique for finding answers in forums for extracted questions. The input is a forum thread with the questions annotated; the output is a list of ranked candidate answers for each question. In general, paragraphs are good answer segments in forums. For example, given a question “Can anyone tell me where to go at night in Orlando?”, its answer “You would be better off outside the city. look into International drive or Lake Buena Vista. for nightlife try Westside in the Disney Village. have a look at MARRIOTTVILLAGE.COM. located in LBV” is a paragraph. It is desirable to assume that the answers to a question usually appear in the posts after the post containing the question. Hence, for each question assume its set of candidate answers to be the paragraphs in the following posts of the question.

In accordance with descriptions related to the present invention, the following section describes three IR methods to rank candidate answers for a given forum question: cosine similarity, query likelihood language model, and KL-divergence language model. Following the description of the IR methods, is a summary of how to adapt the classification method to rank answers.

In the first IR method, given a question q and a candidate answer a, their cosine similarity weighted by inverse document frequency (idf) can be computed as follows (equation 1):

$$COS ( q , a ) = \frac{{\sum }_{w ∈ q , a} f ( w , q ) \cdot f ( w , a ) {( {idf}_{w} )}^{2}}{\sqrt{{\sum }_{w ∈ q} {( f ( w , q ) {idf}_{w} )}^{2}} \times \sqrt{{\sum }_{w ∈ a} {( f ( w , a ) {idf}_{w} )}^{2}}}$$

where f(w,X) is the frequency of word w in X, idfw is inverse document frequency (idf). Each document corresponds to a post in the thread of question q.

In the second IR method, the probability of generating a question q from language models of candidate answers can be used to rank candidate answers. Given a question q and a candidate answer a, the ranking function for the Query likelihood language model using Dirichlet smoothing is as follows (equations 2 and 3, respectively):

$$\begin{matrix}QL ( q \vert a ) = {\prod }_{w ∈ q} P ( w \vert a ) \\ P ( w \vert a ) = \frac{\vert a \vert}{\vert a \vert + λ} \cdot \frac{f ( w , a )}{\vert a \vert} + \frac{λ}{\vert a \vert + λ} \cdot \frac{f ( w , C )}{\vert C \vert}\end{matrix}$$

where f(w,X) denotes the frequency of word x in X, and C is the background collection used to smooth language model.

In the third IR method, the KL-divergence language model, the invention constructs unigram question language model M_{q} for question q and unigram answer language model Mₐ for answer candidate answer a. the method then computes KL divergence between the answer language Mₐ and question language model M_{q} using the following equation. (equation 3)

$$KL ( {M}_{a} \vert \vert {M}_{q} ) = {\sum }_{w} p ( w \vert {M}_{a} ) log ( p ( w \vert {M}_{a} ) / p ( w \vert {M}_{q} ) )$$

The above classification methods extract knowledge from forums, though not question-answer pairs. Classifiers are built to extract input-response pairs using content features, e.g., the number overlapping words between input and reply post) and structural features, e.g. is the reply posted by the thread starter. The other method uses slightly different features. Conversely, the present invention treats each question and candidate answer pair as an instance, compute features for the pair, and train a classifier. The value returned by a classifier, called as classification scores, can be used to rank the candidate answers of a question. The classification based re-ranking method needs training data which are usually expensive to get.

The methods presented above do not make use of any inter candidate answer information, while the candidate answers for a questions are not independent in forums. In accordance with the present invention, the following section describes an unsupervised graph-based method that considers the inter-relationships of candidate answers.

The graph-based propagation method is used for finding answers in forum data. If a candidate answer is related to, or similar to, an authoritative candidate answer with high score, the candidate answer, which may not have a high score, is also likely to be an answer. The following section first describes how to build graphs for candidate answers, and then how to compute ranking scores of candidate answers using the graph.

Given a question q, and the set A_{q} of its candidate answers, the invention utilizes a step where it builds a weighted directed graph denoted as (V, E) with weight function w: E→R, where V is the set of vertices and E is the set of directed edges and w(u→v) is the weight associated with edge u→v. Each candidate answer in A_{q} will correspond to a vertice in V. The problem is how to generate the edge set E.

Given two candidate answers aₒ and a_{g}, use the KL-divergence language model KL(aₒ|a_{g}) (resp. KL(aₒ|a_{g})) to determine whether there will be an edge aₒ→a_{g} (resp. a_{g}→aₒ). The use of KL divergence language model can be motivated by the following example: consider two candidate answers for a question q: can tell me some about hotel. a₁: world hotel is good but I prefer century hotel and a2: world hotel has a very good restaurant. Knowing that a₂ is answer would provide evidence that a₁ is also somewhat important and could be answer, but not vice versa. This is because a₁ concerns both world hotel and century hotel while a₂ concerns only world hotel. KL-divergence language model allows us to capture the asymmetry in how the authority is propagated.

Create the definitions of a generator and offspring that will frame edge generation. Definition 1: Given two candidate answers aₒ and a_{g}, if 1=(1+KL(aₒ|a_{g})) is larger than a given threshold p, an edge will be formed from aₒ to a_{g}. We say that a_{g} is a generator of aₒ and aₒ is an offspring of a_{g}.

According to the definition, we can determine whether to generate an edge from aₒ to a_{g}, and similarly we can determine the presence of an edge from aₒ to a_{g} by comparing KL(a_{g}|aₒ) and μ. The parameter p in the definition is determined empirically and we found in our experiments that our methods are not sensitive to the parameter. Allow self-loop, i.e., each candidate answer can be its own generator. The self-loop edge will allow that one candidate answer is its own generator and offspring. This will also function as a smoothing factor in computing weight and authority. Note that one candidate answer can be a generator of multiple candidate answers and that it is possible for one candidate answer to have no generator. In the extreme case, there are no edges in the graph and thus graph propagation is turned off.

After both vertices and edges are obtained, the remaining step is to compute weight for each edge. One straightforward way is to use the KL-divergence score. To achieve better performance, the invention considers two more factors in computing weight.

In one additional factor, the replying posts far away from the question post usually are less likely to contain answers for the questions in the post in forums. Hence, when building the digraph for a question, consider the distance between a candidate answer and the question, denoted by d(q, a).

In accordance with another factor, posts in forums from authors with high authority are more likely to contain answers. Some forums may provide the authority level of authors while many forums do not have the information. For this invention, estimate the authority of an author in terms of the number of his replying posts and the number of threads initiated by the person using the following equation (equation 4):

$$author ( i ) = \frac{{( \# {reply}_{i} )}^{2} / \# {start}_{i}}{{max}_{j ∈ l} ( {( \# {reply}_{j} )}^{2} / \# {start}_{j} )}$$

where I is the set of all authors in a forum.

Given two candidate answers aₒ and a_{g}, the weight for edge aₒ→a_{g} is computed by a linear interpolation of the three factors, namely the similarity computed from KL-divergence KL(aₒ|a_{g}), the distance of a_{g} from q, and the authority of the author of a_{g}. (Equation 5)

$$w ( {a}_{o} -> {a}_{g} ) = \frac{1}{1 + KL ( P ( {a}_{o} ) \vert P ( {a}_{g} ) )} + {λ}_{1} \frac{1}{d ( {a}_{g} , q )} + {λ}_{2} author ( {a}_{g} )$$

The invention employs the normalization method in a PageRank algorithm to normalize weight. Intuitively, given a candidate answer aₒ and a set of its generators Gao in the set of candidate answers A, the weight is normalized, w(aₒ →a_{g}) among all generators g of aₒ, g □ Gₐₒ. (Equation 6)

$$nw ( {a}_{o} -> {a}_{g} ) = \frac{w ( {a}_{o} -> {a}_{g} )}{{\sum }_{g ∈ {G}_{{a}_{o}}} w ( {a}_{o} -> g )}$$

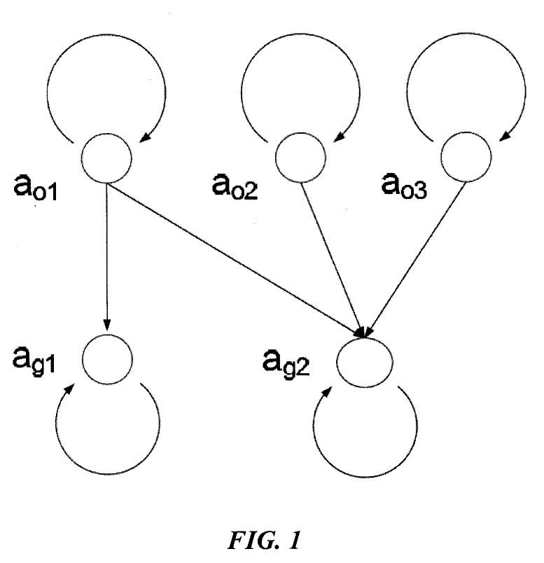

If a candidate answer has multiple generators, the importance of the weight of the generators will be normalized across its generators. The normalization is illustrated with an example. Consider the graph built from the candidate answers of a question given in FIG. 1. The candidate answer aₒ₁ has three generators, a_{g1}, a_{g2} and itself. The weight of edge aₒ₁→a_{g1} will be normalized from three weights w(aₒ₁→a_{g1}), w(aₒ₁→a_{g2}) and w(aₒ₁→aₒ₁). A candidate answer can be a generator of itself and would function as a smoothing factor.

The present invention includes two approaches to integrating the propagated authority with the initial ranking scores that are computed using any of the IR methods described above: Cosine Similarity, Query likelihood language model, and the KL-divergence language model.

In one embodiment, the propagation can be made without an initial score. For each candidate answer a ε Cₐ, the three IR methods can be employed to compute its initial ranking score. Also compute its authority value, which can be understood as the “prior” of the candidate answer to be used to adjust the initial ranking score. The product of the authority value and the initial ranking score between candidate answer a and question q will be returned as the final ranking score for a. (Equation 7)

Pr(q|a):=authority(a).score(q,a)

where score(q|a) is the initial ranking score, and authority(a) implies the significance of answer a in the answer graph.

The following section describes how to compute the authority score for a candidate answer a. Along the lines of a method that computes the authority of documents in information retrieval, the present invention can compute authority for a candidate answer a by the weighted in-degree for each candidate answer a ε Cₐ in the given graph, i.e. the initial authority of a_{g},

$$authority ( {a}_{g} ) = {\sum }_{{a}_{o} ∈ {C}_{a}} nw ( {a}_{o} -> {a}_{g} )$$

If the authority of offspring aₒ (generated by a_{g}) of a_{g} is low, the authority of a_{g} would not be high. Intuitively, if all answers generated by a specific answer are not central, it will not be central. In some cases, the reverse may not be true: even if the generator of a_{g} is important, it is not necessary that its off-spring aₒ is important. The motivation can be modeled by defining the authority of a_{g} recursively as follows (Equation 9):

$$authority ( {a}_{g} ) = {\sum }_{{a}_{o} ∈ {C}_{a}} nw ( {a}_{o} -> {a}_{g} ) \cdot authority ( {a}_{o} )$$

The authority propagation will converge. The edge weights after normalization in Equation 6 correspond to transition probabilities for a Markov chain that is aperiodic and irreducible, and converges to the stationary distribution regardless of where it begins. The stationary distribution of a Markov chain can be computed by a simple iterative algorithm called power method which converged very quickly in our experiments.

In another embodiment, the propagation can be made with an initial score. Unlike the first approach, this approach incorporates the initial score between candidate answer and question into propagation. Given a question q and its set Cq of candidate answer, the ranking score of a candidate answer a, a ε C_{q} will be computed recursively as follows. (Equation 10)

$$Pr ( q \vert a ) = λ \frac{Pr ( q \vert a )}{{\sum }_{t ∈ {C}_{q}} Pr ( q \vert t )} + ( 1 - λ ) {\sum }_{v ∈ {C}_{q}} nw ( v -> a ) \cdot Pr ( q \vert v )$$

where the parameter λ is a trade-off between the score of a and the scores of a's offsprings in the equation, and is determined empirically. For higher value of λ, importance should be given to the score of the candidate answers itself compared to the score of its offsprings. The weight nw is computed in Equation 6.

The propagation will converge and the stationary distribution of a Markov chain can be computed by an iterative power method algorithm. The denominators

$${\sum }_{t ∈ {C}_{q}} Pr ( q \vert t )$$

are used for normalization and the second term in the equation is also normalized so that the weights of all edge leading out of any candidate answer will sum up to 1. Therefore, they can be treated as transition probabilities. With probability (1−λ), a transition is made to the nodes that are generators of the current node. Every transition is weighted according to the similarity distributions.

One benefit of the graph-based method is that it is complementary with supervised methods for knowledge extraction, and techniques for question answering. This section will discuss them respectively. First, the graph-based model can be integrated with classification model when training data is available. Second, learn lexical matchings between questions and answers to enhance the IR methods for answer ranking, and thus graph-based methods.

Graph-based method and classification method can be integrated in two ways when training data is available. First, for each candidate answer and question pair, the results returned by graph-based methods can be added as features for classification method to determine if the candidate answer is an answer of the question. The returned classification score for each candidate answer will be used to rank all the candidate answers of a question. In doing so, the classification model can make use of the relationship between candidate answers. Second, the classification score returned by a classifier is often (or can be transformed into) the probability for a candidate answer being a true answer and can be used as initial score for propagation of graph-based model.

There are many ways to bridge the lexical gap between questions and answers for graph-based model. Question and answer may use different words. For example, why→because. The benefit from enhancing question with answer words can also be compared with that from topic models in TREC question answering. In the method of the present invention, the system learns the mapping by computing the mutual information between question terms and answer terms in a training set of QA pairs. Make use of the answer terms by adding the top-k terms with the highest mutual information to expand question.

The section below describes data from specific implementation examples for question detection and answer detection. In the actual implementation, three forums were selected, forums of different scales to obtain source data: 1) 1,212,153 threads from TripAdvisor forum; 2) 86,772 threads from LonelyPlanet forum; 3) 25,298 threads from BootsnAll Network.

From the source data, two datasets for question identification were generated. From the TripAdvisor data, 650 threads were randomly sampled. Each thread in the corpus contained at least two posts and on average each thread consists of 4.46 posts. Two annotators were asked to tag questions and their answers in each thread. The kappa statistic for identifying questions is 0.96. The kappa statistic for linking answers and questions given a question is 0.69, which is lower than that for questions. The reason would be that questions are easier to annotate while it is more difficult to link answers with questions. Generate two datasets by taking the union of the two annotated data, denoted as Q-TUnion, and the intersection, denoted as Q-TInter. In Q-TUnion a sentence was labeled as a question if it was marked as a question by either annotator; In Q-TInter a sentence was labeled as a question if both annotators marked it as a question.

In the operative example, five datasets for answer detection are given. First, two datasets are generated from the 650 annotated threads by taking the union and intersection of the two annotated data, denoted as A-TUnion and A-TInter, respectively. An answer candidate was labeled as an answer if either annotator marked it as an answer for A-TUnion, and if both annotators marked it for A-TInter. Here questions in Q-Tlnter are used. Second, we randomly sampled 100 threads from TripAdvisor, LonelyPlanet and BootsnAll, respectively. Thus we get another three datasets, denoted as A-Trip2, A-Lonely and A-Boots.

FIG. 2 illustrates performance data of the question detection method against simple rules and the method. More specifically, FIG. 2 provides the results of Precision, Recall and F₁-score. The results were obtained through 10-fold cross-validation for RIPPER and our method. The rule 5W-1H words is that a sentence is a question if it begins with 5W-1H words; The rule Question Mark is that a sentence is a question if it ends with question mark. Although Question Mark achieves good precision, its recall is low. Our method outperforms the simple rules in terms of all the three metrics. Our method also outperforms RIPPER. All the improvements are statistically significant (p-value<0.001). The main reason for the improvement could be that the discovered labeled sequential patterns are able to characterize questions. For example, in one experiment on Q-TUnion, 2,316 patterns for questions were mined, which consist of the combination of question mark, keywords (e.g. 5W1H words) and POS tags (e.g. 1,074 patterns contain question mark); 2,789 patterns for non-questions were also mined. The precision on Q-TUnion is a bit better than that on Q-Tlnter while the recall is worse. This could be understood using Question Mark rule as an example: 1) more sentences ending with “?” are true question in Q-TUnion than Q-Tlnter while they have the same set of sentences ending with “?”, and thus precision on Q-TUnion is higher; 2) there are more true questions in Q-TUnion than Q-Tlnter that cannot be identified using “?”, and recall would be lower on Q-TUnion.

The following section illustrates the evaluation of the performance of graph-based answer detection method and compares it with other methods. The below also illustrates the performance of integrating graph-based method and classification method, and the effectiveness of question-answer lexical mapping.

In this implementation, the performance of the above approaches for answer finding using three metrics: Mean Reciprocal Rank (MRR), Mean Average Precision (MAP) and Precision@1(P@1). MRR is the mean of the reciprocal ranks of the first correct answers over a set of questions. This measure provides an indication of how far down the process should look in the ranked list in order to find a correct answer. MAP is the mean of the average of precisions computed after truncating the list after each of the correct answers in turn over a set of questions. MRR considers the first correct answer while MAP considers all correct answers. P@1 is the fraction of the top-1 candidate answers retrieved that are correct. In the context of extracting question-answer pairs, we are usually more interested in the top-1 returned answer and thus the P@1 measure would be ideal. However, some types of questions, such as asking for advice, often have more than 1 correct answer and it would be useful to find alternative answers. Hence, we report results using all the three metrics.

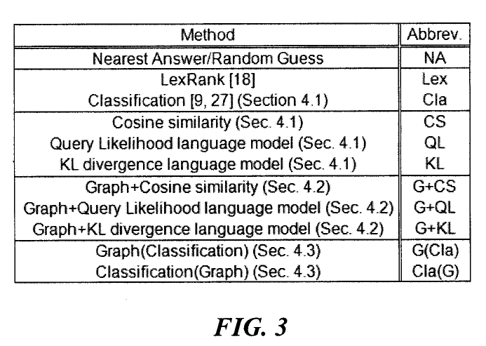

FIG. 3 lists the methods evaluated and their abbreviations. The better of the Nearest Answer and Random Guess was reported as a baseline. The LexRank algorithm was used for answer finding. Although LexRank assumed sentences as answer segments, it is equally applicable to paragraphs used in our experiments. Some of the classification methods were adapted for re-ranking candidate answers and the better one was reported. Graph+Cosine similarity(G+CS) (resp. G+QL and G+KL) represents the graph-based model using cosine similarity (resp. Query Likelihood and KL divergence) as the initial ranking score. Graph(Classification) represents to use results of the classification based re-ranking as the initial score and Classification(Graph) represents to use the results of graph-based models as features for classification based re-ranking.

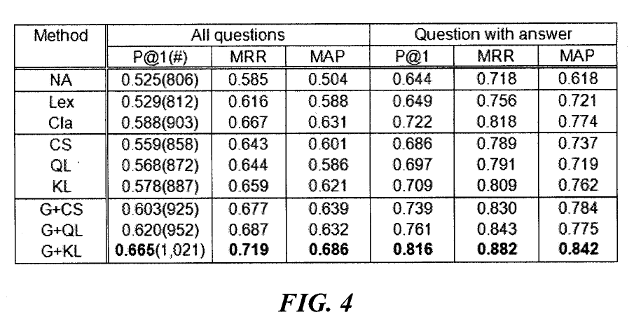

FIG. 4 shows the P@1 (together with the number of correct top-1 answers), MRR scores and MAP scores on A-T Union data containing 1,535 questions from 600 threads. Each question has 10.5 candidate answers on average. As shown in FIG. 4, graph-based methods significantly outperform their respective counter-parts in terms of all the three measures as expected. For example on A-TUnion data G+KL performs 15.1% (resp. 15.7%) better than KL on all questions (resp. questions with answers) in terms of P@1. All the improvement are statistical significant (p-value<0.001). The main reason for the improvements is that G+KL takes advantage of the relationship of candidate answers and some forum-specific features. The reason for reporting the results on the set of questions with answers is that 284 questions do not have answers and setting thresholds for the methods in FIG. 3 failed to detect the questions without answers (deteriorated performance), i.e. all the methods identified wrong answers for all the 284 questions. Therefore, the results reported on questions with answers would be more informative to compare the performance of these methods. Methods for detecting questions without answers is also described herein. The parameters of graph-based method were determined on a development set with 50 threads.

In some cases, G+KL outperforms G+QL and G+CS and they all outperform the baseline method NA. The improvements are statistically significant on all three metrics (p-value<0.001). The classification results are reported on the average of 10-fold cross-validation on 5 runs (20-fold cross-validation returned similar results). The reason for the superiority of G+KL is that it leverages the relationship between candidate answers while the supervised model does not. G+KL also significantly outperforms Algorithm Lex.

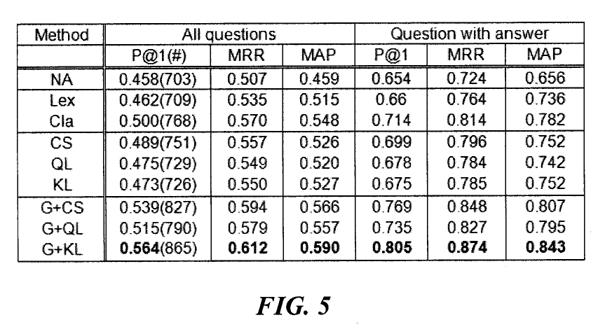

In implementations of the present invention, there were qualitatively similar results on A-TInter as given in FIG. 5. Compared with the results on all questions of A-TUnion, the results on all questions of A-TInter are worse. The main reason behind this is that the A-TInter data contains 460 questions without answers while A-TUnion contains 284. All methods are wrong on these questions. The performance of questions with answer is similar on both datasets.

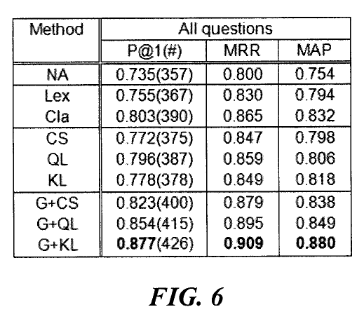

As described above, the invention works well on questions with answers. However, the overall performance may be compromised if there are questions without answers. In the implementations of the present invention, most of first questions of each thread have answers. Of 486 first questions, only 21 of them do not have answers for A-TUnion data and 45 for A-TInter data. The results on the subset of A-TUnion are given in FIG. 6. The table shows that the performance on the subset is much better than that on all the questions, although the subset contains only one third of all question-answer pairs in forums. In real QA services, correct answers would be desirable for users' satisfaction.

In addition, the classification methods would tell if a candidate answer is a real answer to a question, and thus it can be determined if a question has answers by checking each pair of question and answer candidate. Instead, it is preferred to construct a classifier by treating each question and all its candidate answers as an instance. In addition to similarity features between question and its candidate answers, question-specific features can be extracted, such as location of questions in a thread. The classifier returned 689 questions of which 49 do not have answers.

The following description evaluates the different options in graph-base propagation methods. The options include:
Two propagation methods. Propagation without initial score (by default and denoted as G₁) and Propagation with initial score (denoted as G₂);
Different ranking methods including CS, QL and KL
Different methods of computing weight. It is desirable to know the usefulness of distance and authority in computing weight. Hence, make the comparison using KL-divergence alone, de-noted as G_{K} and using all the three factors as in Equation 5 (by default and denoted as G_{A}).

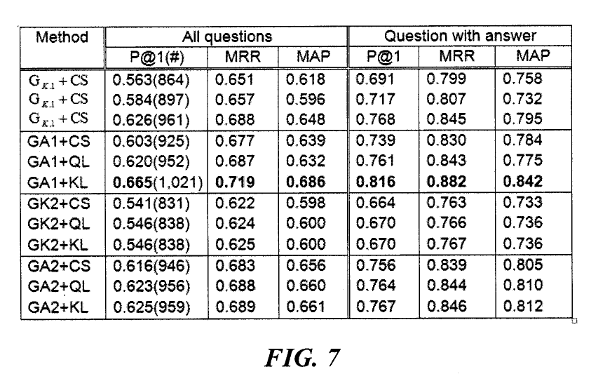

In the graph-based method, propagation without initial score method and all the three factors in Equation 5 are used by default. For example, G+KL represents G_{A,1}+KL. The combination of the different options resulted in the data shown in FIG. 7. For example G_{K,2}+KL represents to use the propagation method, propagation with initial score and use KL to compute weight. The performance of using Equation 5, G_{A}, always outperforms using KL divergence alone G_{K}. This demonstrates the usefulness of forum-specific features used in Equation 5. The ranking method KL always performs better than other two methods CS and QL. The results indicate that propagation without initial score G₁ may outperform the other G₂.

There are three parameters in the graph-based model. They are determined on a development set of 157 questions from 50 threads by considering P@1 in G+KL. For the threshold θ in Definition 1, when varied from 0.1 to 0.35 on development set, the results remained the same and dropped a little if a value larger than 0.35 is used. In one implementation, set it at 0.2. For the two parameters λ₁ and λ₂ in Equation 5, set λ₁=0.8 and λ₂=0.1 based on the results on the development set. Performance did not change much when the process varied λ₁ from 0.5 to 1 and λ₂ from 0.1 to 0.2. Set λ=0.2 in Equation 10; and it may not change performance when the process varies it from 0.1 to 0.3.

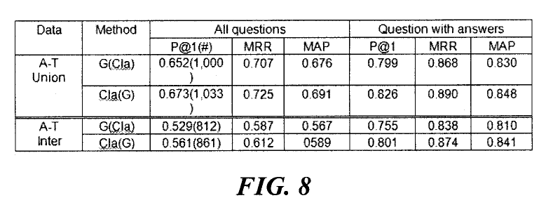

The following section describes the integration of classification based re-ranking method and graph-based method. More specifically, the results described below experiment illustrate two ways of integration. FIG. 8 provides the results on A-TUnion (upper) and A-TInter (lower). By comparing the results of G(CLa) with those of Cla in FIGS. 4 and 5, it can be interpreted that the graph-based method may improve the classification method Cla by using the result of Cla as the initial score of graph-based method. By comparing CLa(G) with Cla in FIGS. 4 and 5, it is shown that using the results of graph-based methods as features may improve method Cla. The reason for the improvement is that the integration can consider the relationship between candidate answers, while Cla alone does not consider the relationship between candidate answers.

The following section describes the effectiveness of the lexical mapping. More specifically, the following evaluates the effect of lexical mapping between question and answer described above. The results are favorable: the learned lexical mapping did not help for all the three ranking methods (CS, QL and KL). Due to space limitation, the detailed results are ignored. In some cases, the lexical mapping is not effective for forum data. For example, lexical mapping how much→number would be useful in TREC QA to locate answers. In our corpus, 31.2% correct answers for how much questions do not contain a number. One example of answer to how much questions is “you can find it from the Website.” On the other hand, many answer candidates containing number are not real answers.

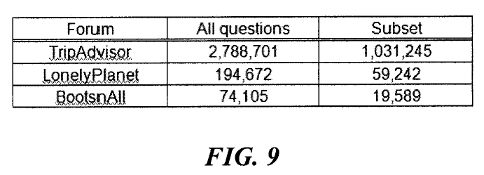

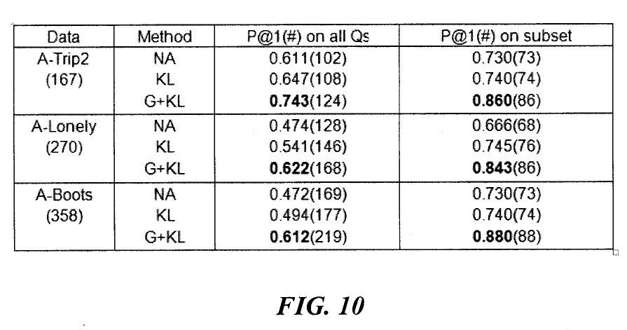

The above described question detection method and answer detection method G+KL were applied to the three forums that were crawled. The number of extracted question-answer pairs and its subset (the first question-answer pairs in each thread) is given in FIG. 9. Three methods were evaluated on the three datasets. An annotator was asked to check the top-1 return results of the three methods. The results are illustrated in FIG. 10. The number of all questions in each data is given below the name of data, and the number of questions in subsets in each data is 100. The same trends for the three methods were observed on the three data: both KL and G+KL outperform the baseline method NA and G+KL outperforms KL (statistically significant, p-value<0.01).

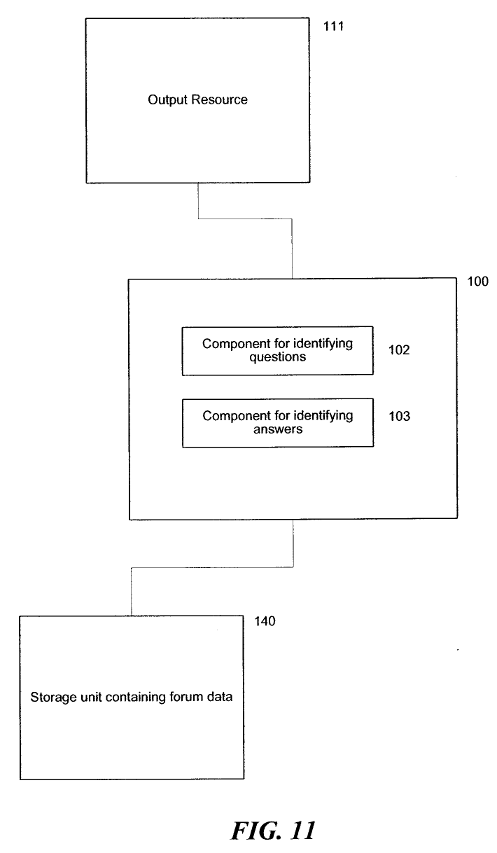

Referring now to FIG. 11, a block diagram of one embodiment of the present invention is briefly described. The system 100 contains a component for identifying the questions 102 and a component for identifying answers 103. The components 102 and 103 can be combined into one component having any combination of features described above. The storage unit 140 which may include forum data, is communicatively connected to the system 100, which may be a part of the system 100 or a separate unit connected via a network. The output resource 111 can be any one of or a combination of devices, such as a graphical display unit, another computer receiving the data for processing, the storage unit 140, a printer, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A system for discovering questions and answers, the system comprising:
a component for identifying questions from text sections of a database, wherein the questions are identified using a classification-based method that utilizes sequential pattern features automatically extracted from both questions and non-questions text sections;
a component for identifying answers from text sections of the database, wherein the answers are identified by the use of a graph-based propagation model, and wherein the component for identifying answers is configured to produce a list of ranked candidate answers for the identified questions.

2. The system of claim 1 wherein the component for identifying answers is configured and arranged to define and process the inter-relationships of candidate answers.

3. The system of claim 1 wherein the component for identifying answers further comprises a component for normalizing a weight value for the candidate answers.

4. The system of claim 1, wherein the component for identifying answers further comprises a component for computing an initial ranking score.

5. The system of claim 1, wherein the component for identifying answers further comprises a component for computing an authority score for at least one candidate answer.

6. The system of claim 1 wherein the component for identifying answers integrates the graph-based propagation model with a classification method.

7. The system of claim 1, further comprising a component configured and arranged for learning lexical matchings between questions and answers to enhance the processing methods for answer ranking.

8. A method for discovering questions and answers, the method comprising:
identifying questions from text sections of a database, wherein the questions are identified using a classification-based method that utilizes sequential pattern features automatically extracted from both questions and non-questions text sections;
identifying answers from text sections of the database, wherein the answers are identified by the use of a graph-based propagation model, and wherein the component for identifying answers is configured to produce a list of ranked candidate answers for the identified questions.

9. The method of claim 8 wherein the process for identifying answers is configured to define and process the inter-relationships of candidate answers.

10. The method of claim 8 wherein the process for identifying answers further comprises a process for normalizing a weight value for the candidate answers.

11. The method of claim 8 wherein the process for identifying answers further comprises a process for computing an initial ranking score.

12. The method of claim 8 wherein the process for identifying answers further comprises a method for computing an authority score for at least one candidate answer.

13. The method of claim 8 wherein the process for identifying answers integrates the graph-based propagation model with a classification method.

14. The method of claim 8 wherein the method further comprises a method for learning lexical matchings between questions and answers to enhance the processing methods for answer ranking.

15. A computer-readable storage media comprising computer executable instructions to, upon execution, perform a process for discovering questions and answers, the process including:
identifying questions from text sections of a database, wherein the questions are identified using a classification-based method that utilizes sequential pattern features automatically extracted from both questions and non-questions text sections;
identifying answers from text sections of the database, wherein the answers are identified by the use of a graph-based propagation model, and wherein the component for identifying answers is configured to produce a list of ranked candidate answers for the identified questions.

16. The computer-readable storage media of claim 15, wherein the process for identifying answers is configured to define and process the inter-relationships of candidate answers.

17. The computer-readable storage media of claim 15, wherein the process for identifying answers further comprises a process for normalizing a weight value for the candidate answers.

18. The computer-readable storage media of claim 15, wherein the process for identifying answers further comprises a process for computing an initial ranking score.

19. The computer-readable storage media of claim 15, wherein the process for identifying answers further comprises a method for computing an authority score for at least one candidate answer.

20. The computer-readable storage media of claim 15, wherein the process for identifying answers integrates the graph-based propagation model with a classification method.
